(19) United States
(12) Patent Application Publication
(10) Pub. No.: US 2010/0017836 A1
(43) Pub. Date: Jan. 21, 2010

(54) Method and Device for Stream Adaptation

(76) Inventor: Elmar Trojer, Taby (SE)

Correspondence Address: ERICSSON INC., 6300 LEGACY DRIVE, M/S EVR 1-C-11, PLANO, TX, 75024, US

(21) Appl. No.: 12/374,608

(22) PCT Filed: Jul. 25, 2006
(86) PCT No.: PCT/SE2006/050272

§ 371 Date: Jan. 21, 2009

(51) Int. Cl. H04N 7/173; H04B 7/02; H04B 1/38; H04L 12/56; H04W 4/00

(52) U.S. Cl. 725/114; 375/267; 375/222; 370/389; 455/422.1

(57) ABSTRACT

A stream adaptation device and method of adapting source data streams to the attainable transmission rate of a bandwidth-limited channel such as a Digital Subscriber Line (DSL). A plurality of transcoding units each receive a source stream at a given rate and transcode the stream into a plurality of transcoded streams of lower transmission rates. A polling unit retrieves the current quality of the DSL line from an IPDSLAM to which the DSL line is connected. A controller calculates the rates to be used on the DSL line for the different source streams. A selector then selects a combination of an original source stream and/or transcoded streams of lesser rates that fits the quality of the DSL line. A multiplexer combines the selected source streams and/or transcoded streams onto the DSL line.

The present invention relates to a method and a device for adapting the rates by which one or more video, audio or data channels are streamed to a user over a bandwidth limited transport medium (local loop). The rates by which the program channels are streamed are adapted to the quality of the transport media in terms of bandwidth. The invention also relates to a network node that provides the adaptation method.

### TECHNICAL FIELD OF THE INVENTION

The invention pertains to distribution of TV (IPTV) and video on demand (VoD) using the Internet Protocol stack as carrier of the service. In general, the invention copes with the transport of data streams over bandwidth limited media where the available data-rate is scarce.

### BACKGROUND

FIG. 1 illustrates an access domain 1 with an Ethernet switch 2 with a link 3 over which data material, such as video, audio or data, is transported from a non-shown IP based service network using Ethernet or IP based transmission technology. POTS (Plain Old Telephony Service) services from a POTS domain 6 are transported over a link 5. Signals on the two links 4 and 5 are multiplexed together in a non shown combiner of an IPDSLAM (IP Digital Subscriber Line Access Multiplexer) 7 and are transported to a plurality of CPEs (Customer Premises Equipments) 8 over respective DSLs (Digital Subscriber Lines) 9. The IPDSLAM has a plurality of connectors 10 each connected to a respective DSL. For clarity reasons only one connector, one DSL and one CPE are shown. The shown CPE sits in the premises of a non shown user. Typically 8, 10 or 12 different CPEs are connected to one and the same IPDSLAM over respective DSLs as symbolically illustrated at the vertical line of dots. A CPE comprises a splitter 11 that splits the two signals on the DSL into a POTS signal and a DSL signal. The POTS signal goes to a telephone 12. The DSL signal goes to a set top box 13 to which a not shown TV or video equipment is connected. Depending on the CPE, the DSL signal may also go to a PC 14 and a VoIP (Voice over IP) telephone 15.

The Ethernet switch 2 has control functions for the IPDSLAM allowing users connected to the IPDSLAM to send individual requests for individual programs to a non shown content server placed in the content provider domain. As an alternative, the video or content server can be directly connected to the Ethernet switch 2.

An IPDSLAM is provided with means that monitors the quality of the DSL. An IPDSLAM is also provided with a functionality called impulse noise protection (INP) that comes into action when there is impulse noise, for example electrical noise in or in the surroundings of a user's premises. The INP functionality reduces the effects of the noise, but degrades the transmission rate.

The length of a DSL depends of the distance between geographical location of the CPE and the IPDSLAM. This distance is commonly referred to as the loop length. An IPDSLAM is typically located at a CO (central office) of a network operator or in an outdoor cabinet.

FIG. 2 illustrates how the transmission rate on an individual DSL varies with the loop length. Curve 16 is an ideal curve obtained with the standard ADSL2+ transmission mode, [Ref 1]., where no noise is on the local loop. Curve 17 illustrates how cross talk from other DSLs connected to the same IPDSLAM and placed in the same binder (bundle of lines) degrades the transmission rate on an individual DSL. Curve 18 illustrates how INP degrades the transmission rate on an individual DSL in case of impulse noise degradation. Vertical lines L1, L2 and L3 are three different DSLs with different loop lengths.

L1 is a long DSL that goes to a user located about 4.5 km from the IPDSLAM 7, L2 is a medium long DSL to another user at a distance of 3 km from the same IPDSLAM and L3 is a short DSL to yet another user at a short distance of 1 km from the same IPDSLAM.

The maximum point of curve 16 has been calculated for the case where the IPDSLAM is connected directly to the CPE not using any DSL. At zero distance there is a theoretical figure of a maximum transmission rate of 24 Mbps in the downstream direction (for ADSL2+). The curve is then falling with increasing distance between the IPDSLAM and the CPE and at 7 km no transmission is possible.

An MGPEG2 coded program channel has a bit rate of about 7 Mbps. Whether a local loop can transfer a channel to a CPE depends on the quality of the local loop; the quality being measured in terms of number of mega bits (Mbps) available on the local loop. There are two main types of noise that degrades the quality; cross talk and impulse noise. As mentioned above there are many DSLs, exemplary ten, that go to a IPDSLAM. These DSLs are bundled in binders at the CO and in the surroundings of the IPDSLAM. Close to the user (user area) the bundle is then forged to the individual users (drop-lines). An individual DSL in a bundle is subjected to cross talk from traffic on the other DSLs in the bundle. Impulse noise is generated in or in the vicinity of a customer's premises.

Look at the long line L1. Ideally it has a rate of about 14 Mbps if no noise is present. If cross talk only is present on L1 the cross talk penalty is about 8 Mbps and L1 has a rate of about 6 Mbps. In the illustrated case both cross talk and impulse noise are present. The impulse noise reduces the bandwidth with about 3 Mbps. To sum up the available rate of line L1 is about 3-4 Mbps as has been marked out at point 20. Since the line is quite long, the degradation of the rate due to impulse noise protection is small, i.e. the DSL framing does not constrain the data rate. For short loops, framing limitations in DSL provoke a hard limit on the data rate as shown by horizontal part of curve 18.

Since a channel requires about 7 Mbps to be transferred it is not possible to watch any channel at the CPE associated with L1 since the line can transfer only about 3-4 Mbps.

Now look at the 3 km long DSL line L2. Ideally it has a rate of about 20 Mbps, but in the example given, it is subjected to cross talk. Its cross talk penalty is about 8 Mbps and the rate of L3 is therefore only about 11-12 Mbps as indicated at point 21. L2 can therefore take at least one channel. If L2 also suffers from impulse noise protection, which kills about 6 Mbps, its rate would be only about 5-6 Mbps and the line would not be able to transport a single channel.

Finally, look at the short DSL line L3. It has an ideal rate of about 24 Mbps. If crosstalk but no impulse noise is present, the rate is limited to 23 Mbps as indicated by point 22. In this case, the available rate allows for transmission of two or even three channels. If now also impulse noise protection is enabled due to severe impulse noise on the line, the rate would drop to just 6 Mbps and no single channel would be possible on that line/noise combination.

Generally one can say that the longer the line is, the less the INP limits the rate. On short lines impulse noise gives the largest penalty and is problematic. Cross talk is largest at medium long lines.

FIG. 3 depicts the situation with the three lines L1, L2 and L3 in FIG. 2 are connected to one IPDSLAM 7 which is connected to an Ethernet switch 2 or video server over the link 4.

Link 4 is for clarity reasons illustrated to carry only two channels CH1 and CH2 each one of 7 Mbps in bandwidth. The connectors are numbered from 1 to 10 in case the IPDSLAM supports 10 parallel DSLs. Typically link 4 carries about 30 channels and the ten users connected to the IPDSLAM can select any of these. With the examples given at points 20, 21 and 22 the CPE associated with L1 can not watch any channel, the CPE at L2 can watch CH1 or CH2, and the CPE at L3 can watch CH1 and CH2. The POTS service is available at all of the CPEs, since it is operated in a different frequency band.

There are two main problems associated with the prior art discussed above.

The first relates to connectivity. In the above example connectivity is lacking at the CPE associated with L1, since it is not possible to connect a program to the CPE associated with line L1.

The second relates to multichannel transmission. In the above example parallel transmission is not possible at the CPE associated with line L2; only one channel can be watched at the CPE associated with L2.

### SUMMARY

The present invention aims to ease the above mentioned problems.

The following numbered advantages [ADV1], [ADV2] etc. are achieved with the invention and in the detailed description below references are given to them in order to avoid repetitions.

[ADV1] An advantage achieved with the invention is that it is possible to transcode a channel to a lower rate compared to the source stream rate. This lower rate is selected so that the resulting stream fits the quality the bandwidth limited transport medium such as the DSL line. Thereby it will always be possible to connect/watch at least one channel with a reduced quality (IPTV connectivity).

[ADV2] Another advantage achieved with the invention is multichannel transmission to one and the same CPE. This is provided by transcoding a plurality of channels to different combinations of lower rates as compared to the rates of the source streams. These combinations are selected so that they fit the quality of the line they are transmitted on. One channel may be transmitted with the highest quality, while others are transmitted with reduced qualities. Other quality combinations are also possible. It is also possible to transcode and multiplex additional channels on the line.

[ADV3] By using statistical multiplexing it is even possible to code two or more channels together and transmit them either with a quality that is better than if each channel would be coded separately or with a rate that is lower than the sum of the individual rates.

[ADV4]: The basic principle behind the invention allows for inexpensive large-scale deployment in a public multi-media network.

### BRIEF DESCRIPTION OF THE DRAWINGS

FIG. 1 illustrates a traditional network for providing contents and POTS services to CPEs,

FIG. 2 is a diagram illustrating the loop length versus loop transmission rate for various types of noises on a DSL,

FIG. 3 is a schematic view of an IPSLAM with connected DSL lines of different qualities,

FIG. 4 is a block diagram of a stream adaptation device in accordance with the invention

FIG. 5 is a schematic view of two IPDSLAMs connected to respective stream adaptation devices provided in a node of a network,

FIG. 6 is a block diagram of a first embodiment of a transcoder unit in accordance with the invention, and

FIG. 7 is a block diagram of a second embodiment of a transcoder unit in accordance with the invention.

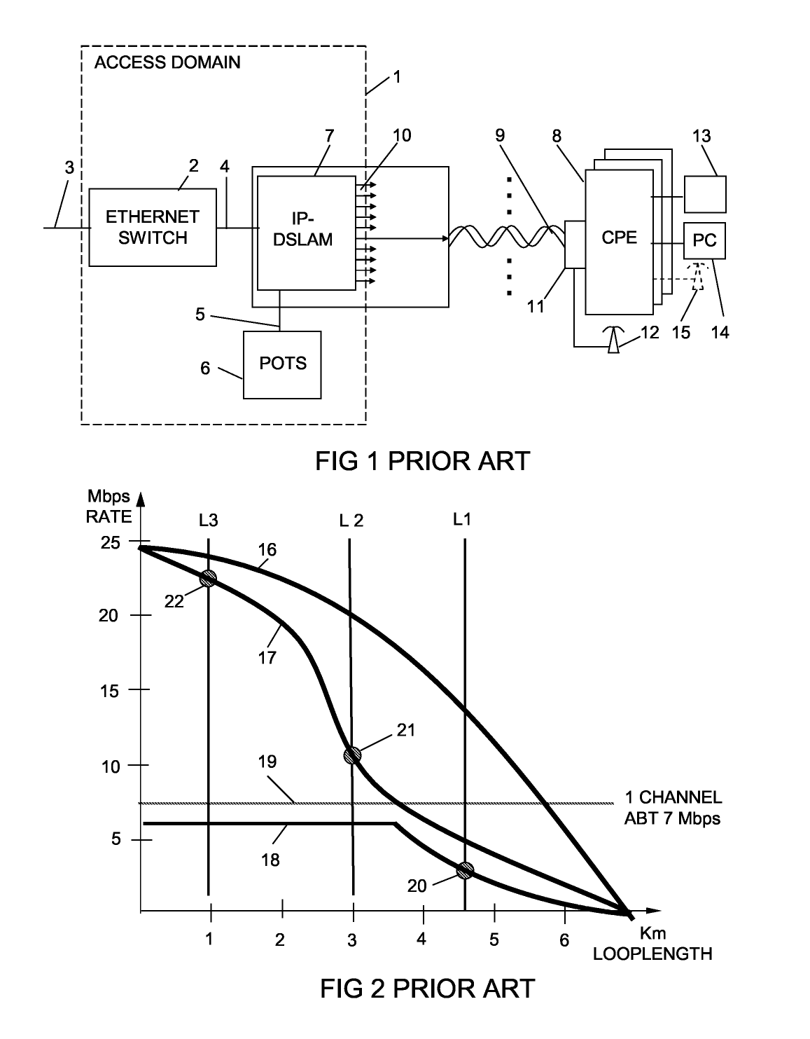

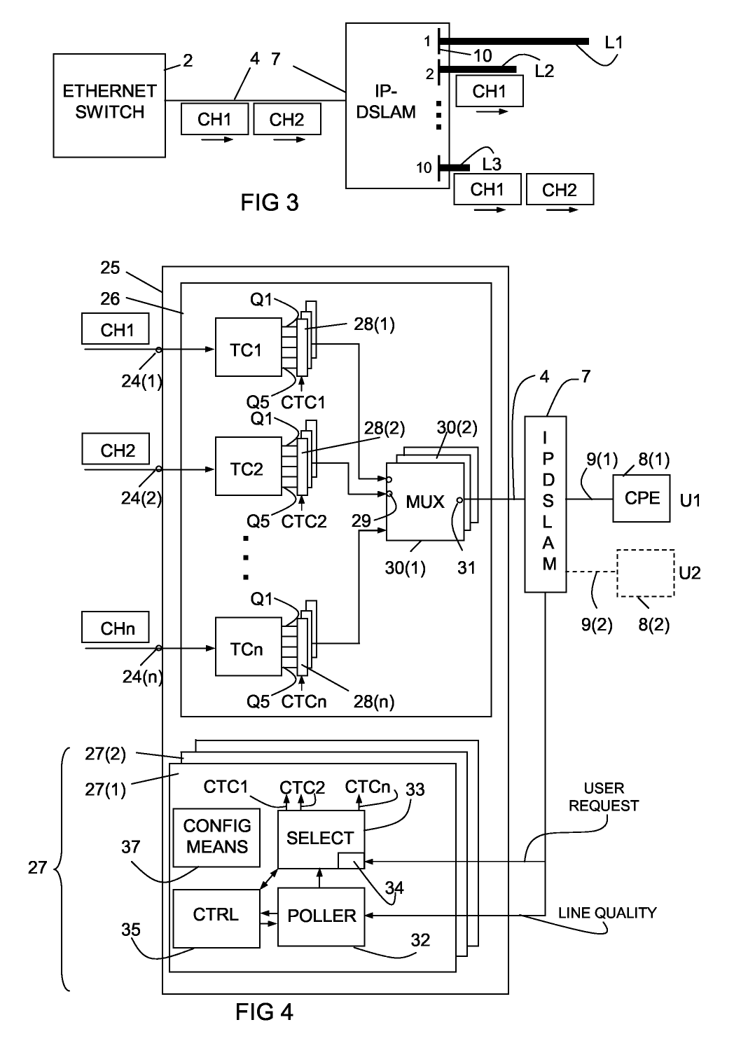

### DETAILED DESCRIPTION OF EMBODIMENTS

FIG. 4 is a block diagram of a stream adaptation device 25 in accordance with the invention. It comprises a general transcoder part 26 and a plurality of individual control units 27(1), 27(2) to 27(10), each one associated with a respective DSL line 9(1), 9(2) to 9(10) connected to the corresponding connector 10. For clarity reasons only DSL lines 9(1) and 9(2) and their respective control units 27(1) and 27(2) are shown.

The general transcoder part comprises a plurality of transcoder units TC1, TC2 to TCn, each one receiving a respective source stream 24(1), 24(2) to 24(n). Source stream 24(1) carries a program channel CH1, source stream 24(2) a channel CH2, and source stream 24(n) a channel CH(n). Exemplary n=30 implying that there are 30 different program channels a user can select among.

A transcoder unit TC takes its source stream and transcodes it into a plurality of transcoded streams of lower, finite and configurable rates or qualities Q1-Q5. The transcoded streams appear simultaneously at a corresponding number of outputs at the TC. Exemplary each source stream is an MPEG2 coded stream with a rate of about 10 Mbps which is transcoded into 7 Mbps, 5 Mbps, 3 Mbps and 1 Mbps. At the output of each transcoder unit, the original source stream at 10 Mbps plus the four streams with rates 7, 5, 3 and 1 Mbps are available. It should be noted that these streams appear simultaneously in parallel at the outputs Q1-Q5. The stream at Q1 is the source stream with the highest quality Q1. At output Q2 the 7 Mbps transcoded stream appears and it has the next best quality Q2. Similarly the 5, 3 and 1 Mbps transcoded streams have the falling qualities Q3, Q4, and Q5 respectively. Q5 is thus the transcoded stream with the lowest ranked quality.

The Q1-Q5 outputs are connected to respective inputs of a stream quality multiplexer 28(1) that in response to a control signal CTC1 from the control unit 27(1) associated with DSL line 9 picks out the rate by which program channel CH1 shall be transmitted on DSL line 9.

Similarly the Q1-Q5 outputs of TC2 are connected to another stream quality multiplexer 28(2) that in response to another control signal CTC2 from the same control unit 27(1) associated with DSL line 9 picks out the rate by which program channel CH2 shall be transmitted on the same DSL line 9 to the CPE of a user, in the illustrated case DSL 9(1) to user U1.

In a similar manner, a plurality of different program channels at different rates are picked out at respective transcoder units TC3 to TCn, and the picked out streams are brought to inputs 29 of a channel multiplexer 30(1) which brings the picked out streams together at its output 31 and transmits them on link 4 to the IPDSLAM from where they are transmitted on DSL line 9 to user 1. In this manner user 1 can watch many programs with selected, different or similar, qualities Q, as determined by the respective control signals CTC1 to CTCn. These qualities Q have been selected by the control unit 27(1) and are of such rates that they in combination fit the quality of line 9; [Adv. 1], [Adv. 2]. How this is achieved will be described next.

First it is noted that an IPDSLAM comprises functionality that monitors the line conditions on the DSLs connected to it. Among other things the line conditions comprise information on the transmission rate that is currently used on each connected DSL in both directions. This information is stored in a non-shown MIB (Management Information Base) in the IPDSLAM. In accordance with the invention the line conditions associated to an individual DSL are used to adapt the rate of the streams that are transmitted on the individual DSL; [Adv. 1].

Retrieving means 32, exemplary a poller, fetches the line information associated to DSL 9 from the IPDSLAM and brings it to a selector 33 that comprises receiving means 34 for receiving a user's requests for transfer of individual program channels. Communication between the IPDSLAM and the retrieving means takes place using exemplary the SNMP (Simple Network Management Protocol).

A controller 35 receives the line information and the user's requests and calculates the rates that are possible to use for the requested program channels with respect to the current line quality on the individual DSL line 9. Exemplary the line is bad and can take only 5 Mbps in which case the controller suggests transfer of one channel with Q3 quality (5 Mbps), or one channel Q4 quality+one channel with Q5 quality (4 Mbps), or for example three channels all with Q5 quality (3 Mbps).

Exemplary the line is good, then the controller suggests transfer of three channels with Q2 quality, or one channel with Q1 quality and two with Q2 quality, or any other combination of channels and qualities; [Adv. 2].

There may be an interaction between the user and the controller in this phase, exemplary over a graphic interface at the PC of the user, and the user may select the options the controller suggests.

When the options for rates to be used on the DSL have been determined, either by the controller, the user or both, the controller communicates the rates to be used to the selector and the selector generates corresponding control signals to the involved stream quality multiplexers 28(1) to 28(n). A control signal will set a stream quality multiplexer, so that it lets through the transcoded/non-transcoded stream with the selected transcoding rate to its output.

The distribution of functionalites between the controller, the poller and the selector may be different than described. Exemplary, the selector functionality may be completely incorporated in the controller.

All of the streams generated within the same transcoder unit continues to be generated and are at disposal for use by other users connected to the same or other IPDSLAM. There is one channel multiplexer 28 per user, but just one TC1 to TCn per transcoder part 26.

Exemplary another user, user U2, has a CPE 8(2) that is connected to the same IPDSLAM 7 over DSL 9(2). User U2 may select any of the rates at any of transcoder units TC1-TCn and have the selected streams multiplexed in the MUX 30(2) associated with CPE 8(2). This CPE(2) and its DSL 9(2) are associated with their own control unit 27(2).

The individual control units 27(1) to 27(10) also comprise configuration means 37 for configuration of the transcoding rates at the transcoder units TC1 to TCn.

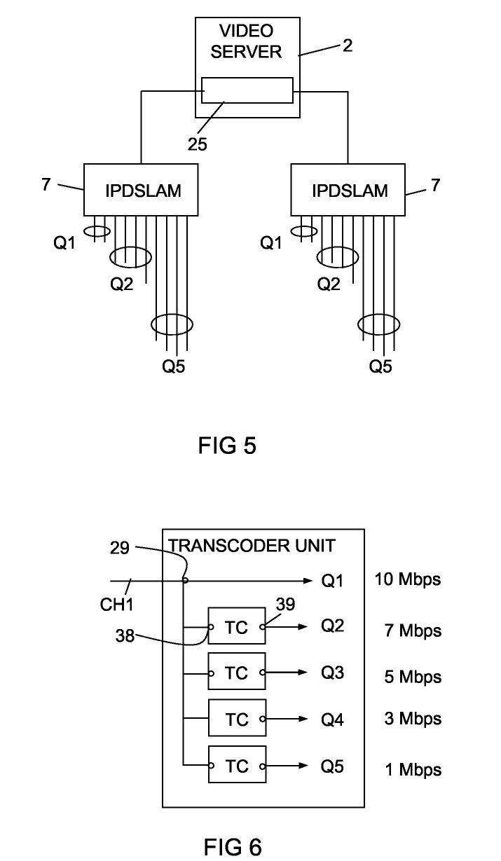

Refer to FIG. 5. In a unicast case in which a user can take a non-used stream transcoder unit, exemplary a CH1 stream of Q1 quality, another can take a CH2 stream of Q1 quality etcetera. This means that it is possible to reuse a lot of streams for a lot of users as is schematically illustrated at the ellipses Q1, Q2 and Q5.

FIG. 5 also illustrates the scalability of the stream adaptation device. Suppose the stream adaptation device 25 is located at the IPDSLAM 7, then the transcoder part 26 can serve the exemplary ten users connected to the IPDSLAM. If the transcoder unit is expensive it would be better to have it located one level higher in a hierarchical network of a video server network. Exemplary a video server at such a higher level may serves exemplary 24 IPDSLAMS. The transcoder part 26 would then serve 240 DSLs with no or minor changes in its structure. The number of control units 27 would increase correspondingly. If the transcoder part is placed even one level higher up in the video server hierarchy then it would serve even more DSLs with no or minor changes. Since the complexity of the transcoder part does not change with the number of CPEs it serves, the stream adaptation device in accordance with the invention is easy to scale in a cost efficient manner; [Adv. 4].

Still referring to FIG. 5 and to a multicast situation in which the stream adaptation device 25 is used. Suppose, for reasons of simplicity, the network in which it is used can offer two program channels CH1 and CH2. All of the users in the network can then watch either CH1 or CH2 and they can watch them on either Q1, Q2, Q3, Q4 or Q5 level. Streams are always generated in the transcoder units TC1 and TC2 and it is always possible to find streams at the server in which the transcoder part is sitting; [Adv. 1].

The channel multiplexer 30 may be a statistical MPEG multiplexer or a statistical multiplexer. The retrieving means 32, the selection means 33, the controller means 35 and the configuration means 37 may be implemented in software, hardware or combinations thereof. Likewise the transcoder units TC1 to TCn, the stream quality multiplexers, and the channel multiplexers 30(1) to 30(10) may be implemented in software, hardware or combinations thereof; [Adv. 3].

FIG. 6 illustrates a first embodiment of the transcoder unit. The transcoder unit comprises a plurality of transcoders, exemplary 4, each transcoding the source stream to a respective rate, exemplary 7, 5 3 and 1 Mbps. Each transcoder has an input 38 and an output 39. The inputs are all connected to the transcoder's input 29 on which the source stream is received. At the outputs the respective transcoded (downcoded) streams are available together with the 10 Mbps source stream.

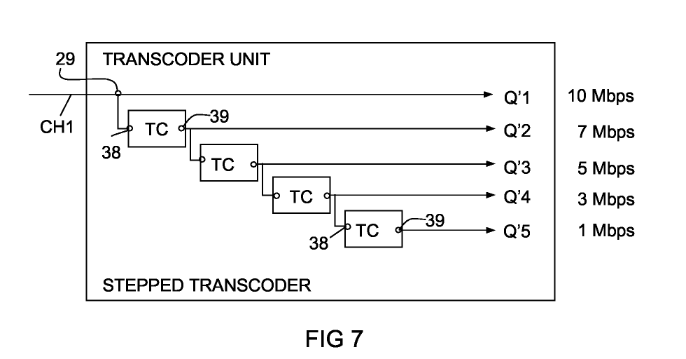

FIG. 7 illustrates a second embodiment of a transcoder unit comprising a plurality of transcoders, exemplary 4, each having an input 38 and an output 39. The source stream, exemplary CH1 at a rate of about 10 Mbps, is received at input 29 and is connected to the input of a first transcoder that transcodes the source stream into exemplary 7 Mbps. The source stream is also present at an output of the transcoder unit. The output of the first transcoder, that is the 7 Mbps stream, is connected to the input of a second transcoder that transcodes the 7 Mbps stream into exemplary 5 Mbps which in turn is transcoded into a stream of 3 Mbps etcetera. A so called stepped transcoder results and its outputs provide five different simultaneous streams at 10, 7, 5, 3, 1 Mbps each associated with a respective quality Q′1 to Q′5 which may differ from those achieved with the FIG. 6 embodiment. It should be noted that almost all MPEG specific parameters (group of picture, mode, etc.) can be affected and changed by the transcoding units.

Although the invention has been described with reference to DSLs and IPDSLAMs it should be understood it can be used for any access medium where the available data-rate is in the order of the stream data-rate and therefore limited (e.g. radio channel).
[Ref. 1] ITU-T G992.5, Asymmetric Digital Subscriber Line (ADSL) transceiver—Extended bandwidth ADSL2 (ADSL2plus), May 2003+Amendment 1 July 2005

1-17. (canceled)

18. A stream adaptation device for selecting a transcoding rate for a data stream that fits a current quality of a bandwidth-limited channel, said device comprising:
a plurality of transcoding units having inputs and outputs, each transcoding unit receiving a different source stream at a given rate and transcoding the source stream into a plurality of transcoded streams of lower transcoding rates;
a polling unit for retrieving the current quality of the bandwidth-limited channel;
a controller for determining a combination of source streams and/or transcoded streams that fits the current quality of the bandwidth-limited channel;
a selector for selecting the determined combination of source streams and/or transcoded streams from the outputs of the transcoding units; and
a channel multiplexer for combining the selected source streams and/or transcoded streams onto the bandwidth-limited channel.

19. The stream adaptation device as recited in claim 18, wherein the selector includes means for receiving a user request for a source stream.

20. The stream adaptation device as recited in claim 19, wherein the selection means includes means for receiving from a single user, a request for transfer of two or more simultaneous programs.

21. The stream adaptation device as recited in claim 20, wherein the controller includes means for calculating which of the plurality of transcoding rates can be used for simultaneous transmission of the requested programs on the bandwidth-limited channel in response to a request for transfer of two or more simultaneous programs.

22. The stream adaptation device as recited in claim 21, wherein the controller includes means for interacting with the user and for proposing transcoding rates that can be used for the different programs that are to be transferred simultaneously on the bandwidth-limited channel.

23. The stream adaptation device as recited in claim 22, wherein each transcoding unit comprises a stepped transcoder, wherein each stepped transcoder comprises:
a plurality of transcoders, each having an input and an output, the input of a transcoder at a given step being connected to the output of a transcoder at a higher step, and the output of the transcoder at the given step being connected to the input of a transcoder at a lower step, the transcoder at the highest step receiving a source stream and the outputs of each transcoder providing the different transcoding rates.

24. The stream adaptation device as recited in claim 18, further comprising means for configuring the transcoding units to output transcoded streams of defined transcoding rates.

25. The stream adaptation device as recited in claim 24, wherein the bandwidth-limited channel is a digital subscriber line (DSL).

26. The stream adaptation device as recited in claim 25, wherein an IP digital subscriber line multiplexer (IPDSLAM) is connected to the DSL, and the channel multiplexer is connected to the IPDSLAM.

27. The stream adaptation device as recited in claim 26, wherein the selector and the IPDSLAM include means for communicating with each other using the Simple Network Management Protocol (SNMP).

28. The stream adaptation device as recited in claim 18, wherein the polling unit includes means for polling a management information base (MIB) to retrieve information on the quality of the bandwidth-limited channel.

29. The stream adaptation device as recited in claim 18, wherein the stream adaptation device is located at a content server, a video server, or at an Ethernet switch.

30. The stream adaptation device as recited in claim 18, wherein the bandwidth-limited channel is a radio connection between a cellular phone and a base station.

31. The stream adaptation device as recited in claim 30, wherein the quality of the radio connection is determined using the bit error rate of the connection.

32. The stream adaptation device as recited in claim 18, wherein the bandwidth-limited channel is an optical fibre.

33. A method of selecting data streams for transmission on a bandwidth-limited channel having a current quality, said method comprising the steps of:
receiving a plurality of source streams of given rates, each source stream being received at a different transcoding unit having an input and multiple outputs;
transcoding each source stream into multiple transcoded streams of lower transcoding rates;
determining the current quality of the bandwidth-limited channel;
determining by a controller, a combination of source streams and/or transcoded streams that fits the current quality of the bandwidth-limited channel;
selecting by a selector, the determined combination of source streams and/or transcoded streams from the outputs of the transcoding units; and
multiplexing the selected source streams and/or transcoded streams onto the bandwidth-limited channel.
